(19) United States
(12) Patent Application Publication
(10) Pub. No.: US 2015/0379083 A1
(43) Pub. Date: Dec. 31, 2015

(54) CUSTOM QUERY EXECUTION ENGINE

(71) Applicant: Microsoft Corporation, Redmond, WA (US)

(72) Inventors: Willis Lang, Madison, WI (US); Nikhil Teletia, Madison, WI (US); Hideaki Kimura, Madison, WI (US); Alan D. Halverson, Verona, WI (US); Srinath Shankar, Madison, WI (US); Karthik Ramachandra, Madison, WI (US)

(21) Appl. No.: 14/314,952

(22) Filed: Jun. 25, 2014

(51) Int. Cl. G06F 17/30

(52) U.S. Cl. CPC G06F 17/30483; G06F 17/30864; G06F 17/30224

(57) ABSTRACT

A custom query execution engine can be generated that captures a query. More particularly, the custom query execution engine can be generated based on combination of a query and an execution engine. Subsequent to generation, a custom query execution engine can be submitted to a system configured to execute the custom query execution engine and evaluate the query over a data store.

### BACKGROUND

The desire to store and analyze large amounts of data, once restricted to a few large corporations, has escalated and expanded. Much of this data is similar to the data that was traditionally managed by data warehouses, and as such, it could be reasonably stored and processed in a relational database management system (RDBMS). However, data is not always stored in an RDBMS. Rather, the data is stored in different systems including those that do not entail a predefined and ridged data model. One example is Hadoop®, from The Apache Software Foundation. Here, data is stored in a distributed file system (HDFS— Hadoop File System) and is analyzed with components such as MapReduce. Although not strictly accurate, data stored outside a RDBMS, such as in a file system like HDFS, is often termed unstructured while data inside an RDBMS is called structured.

While dealing with structured and unstructured data were separate endeavors for a long time, people are no longer satisfied with this situation. In particular, people analyzing structured data want to also analyze related unstructured data, and want to analyze combinations of both types of data. Similarly, people analyzing unstructured data want to combine it with related data stored in an RDBMS. Still further, even people analyzing data in an RDBMS may want to use tools like MapReduce for certain tasks. Keeping data in separate silos is no longer viable.

Various solutions have emerged that enable both structured and unstructured data to be stored and analyzed efficiently and without barriers. One system that emerged is a feature of a RDBM parallel data warehouse that provides a single relational view with SQL (Structured Query Language) over both structured and unstructured data. Here, a single query is split for processing over structured data (e.g., RDBM) and unstructured data (e.g., Hadoop®). In one instance, a portion of a query over structured and unstructured data can be transformed into a map reduce task and provided to Hadoop® for processing.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure pertains to a custom query execution engine. A custom execution engine comprises an execution engine and a query, wherein the execution engine is customized for the query. Upon receipt of a query, a custom execution engine can be generated from the query. Subsequently, the custom query execution engine can be submitted to a system configured to execute the query execution engine and evaluate the query.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a query processing system.

FIG. 2 is a block diagram of a representative query execution-engine.

FIG. 3 is a block diagram of a query execution-engine generation system.

FIG. 4 is a block diagram of submission of a query execution engine for execution.

FIG. 5 is a block diagram illustrating loading and execution of a query execution engine.

FIG. 6 depicts an exemplary three-table join query.

FIG. 7 illustrates a query execution-engine implementation of the three-table join query of FIG. 6.

FIG. 8 shows a map-reduce implementation of the three-table join query of FIG. 6.

FIG. 9 is a flow chart diagram of a method of query processing.

FIG. 10 is a flow chart diagram of a method of query execution-engine generation.

FIG. 11 is a flow chart diagram of a query processing method.

FIG. 12 is a flow chart diagram of a method of query evaluation.

FIG. 13 is a schematic block diagram illustrating a suitable operating environment for aspects of the subject disclosure.

### DETAILED DESCRIPTION

Query processing can be split across structured and unstructured data. For example, structured query language (SQL) processing can be performed by a relational database management system and other processing can be pushed down external to the database to Hadoop® clusters. Conventionally, SQL processing in a database management system is performed, and a MapReduce job is generated and pushed to a Hadoop cluster. However, pushing a MapReduce job to a Hadoop cluster is not highly performant. In fact, the performance of MapReduce is poor since MapReduce does not focus on high performance but rather scalability and fault tolerance.

The next generation of Hadoop® (Hadoop® 2.0), still allows MapReduce jobs to be pushed down but it also introduces a more general computing framework, namely YARN (Yet Another Resource Negotiator). More specifically, the general computing framework application enables submission and execution of an application over a data source. Subsequently, execution can be automatically parallelized and distributed across a plurality of compute nodes. In other words, rather than being limited to pushing down a MapReduce job, an application can be built, submitted, and automatically run.

Details below generally pertain to a custom execution engine. The custom execution engine comprises an execution engine and query, wherein the execution engine is tailored to the query. In other words, a query execution engine can be customized for a query. The custom execution engine can be implemented as an application and submitted for execution to a general-purpose computing framework, such as, but not limited to that provided by Hadoop® YARN, which provides resources from a cluster of compute nodes to support execution of the query execution engine. Rather than be limited to a two-phase map and reduce, arbitrarily complex computations can be performed to process a query. Furthermore, performance can be improved over that of MapReduce.

Various aspects of the subject disclosure are now described in more detail with reference to the annexed drawings, wherein like numerals generally refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

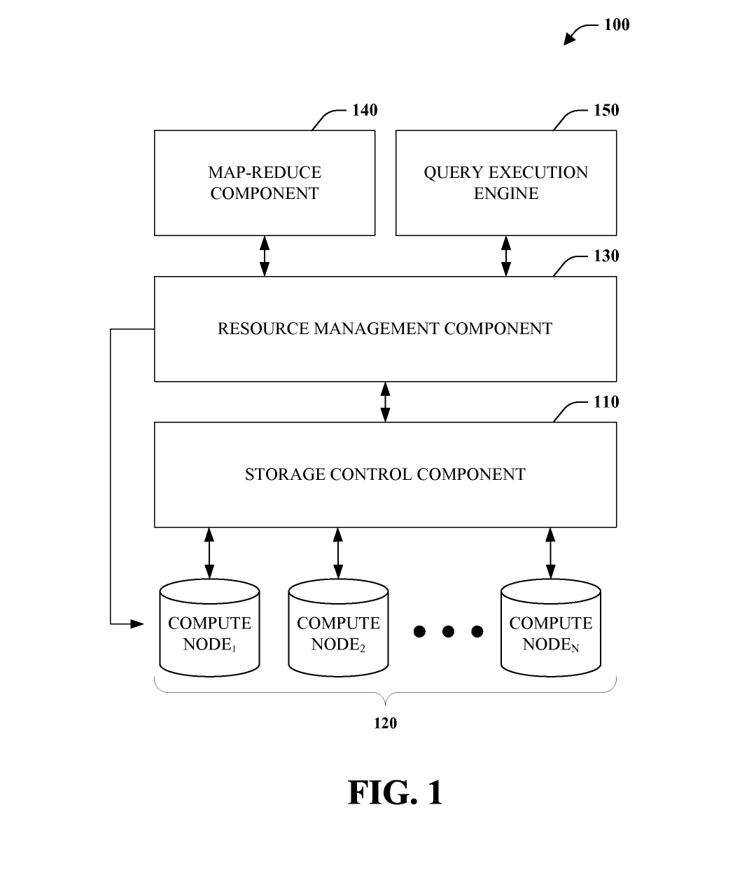

Referring initially to FIG. 1, a query processing system 100 is illustrated. The query processing system 100 includes storage control component 110 and compute nodes 120. The storage control component 110 is configured to control how data is stored and retrieved with respect to one or more compute nodes 120. For instance, the storage control component 110 can implement various mechanisms to segment storage areas as well as name and place data for storage and retrieval. Accordingly, in one instance, the storage control component 110 can correspond to a file system. Although not limited thereto, in one specific implementation that can correspond to the file system of Hadoop® (HDFS).

The compute nodes 120 (NODE₁-NODE_{N}, where “N” is a positive integer) physically store data. More specifically, the compute nodes 120 provide a basic unit of scalability and storage. The compute nodes can also correspond to an appliance node, wherein an appliance is a combination of hardware and software that function together. For example, a compute node can correspond to a physical server and associated storage. Of course, a physical server can be partitioned into multiple virtual servers, which can also each be compute nodes. Furthermore, the compute nodes can be distributed and loosely or tightly connected in such a way to form one or more clusters. In one implementation, the compute nodes 120 can be commodity hardware clusters, wherein commodity hardware is a device or device component that is relatively inexpensive, widely available, and interchangeable, such that it is often replaced rather than repaired upon failure.

The system 100 also includes resource management component 130 configured to manage use of underlying compute nodes 120. In one embodiment, the resource management component 130 can communicate with the compute nodes 120 through the storage control component 110 by one or more applications. In another embodiment, the resource manager component 130 can communicate directly with the compute nodes 120. In other words, the resource management component 130 provides a framework for development and subsequent execution of applications that make of compute nodes 120 as resources. For instance, the resource management component 130 can provide a number of application programing interfaces (API) to allow applications to utilize resources. In this manner, the resource management component 130 operates like an operating system for applications that operate with respect to large volumes of data (e.g., “big data”), often comprising unstructured data. In accordance with one implementation, the resource management component 130 can correspond to Hadoop® YARN. Together, the storage control component 110 and resource management component 130 provide a generalized computing framework conducive to applications that operate over large volumes of data including query processing and data analysis, among others.

MapReduce component 140 is configured to perform MapReduce functionality over large data sets. More specifically, the MapReduce component 140 can be embodied has an application that executes with respect to compute nodes 120 through the storage control component 110 and resource management component 130. The MapReduce component 140 comprises a map procedure that performs filtering and sorting followed by a reduce procedure that performs a summary operation such as aggregation. Further, such operations can be performed in parallel and over distributed data sources. Accordingly, communications and data transfers between data sources are managed. However, MapReduce component 140 does not perform very well, since its primary focus is scalability and fault tolerance.

Query execution engine 150 (also a component as defined herein) is configured to process a query, or in other words, evaluate query, over one or more compute nodes 120. More particularly, the query execution engine 150 can be an application designed to execute with respect to the resource management component 130 and storage control component over the compute nodes 120. Further, the query execution engine 150 can be custom tailored for a particular query. Hence, the process is highly performant because it is custom tailored to the question. Accordingly, the query execution engine 150 is also referred to herein as a custom query execution engine. Furthermore, the query execution engine 150 can also be dynamic since it can be generated at runtime and is independent of the number and particulars of compute nodes 120 provided by the resource management component 130. Further yet, computation is not limited to two-phases as in a map-reduce but rather can be arbitrarily complex. The query execution engine 150 can operate with respect to arbitrary data formats and structure. By way of example and not limitation, the query execution engine 150 can operate with respect to structured relational data or non-structured non-relational data.

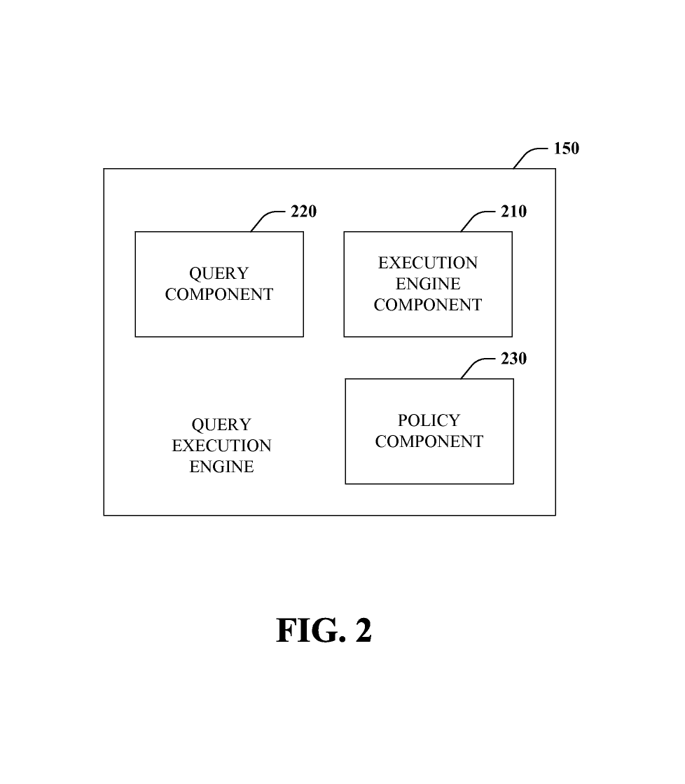

Turning to FIG. 2, a representative query-execution engine is shown. The query execution engine incudes execution engine component 210, query component 220, and policy component 230. The execution engine component 210 is initially configured to perform query processing independent of a particular query. Accordingly, the execution engine component 210 provides mechanisms useful for processing queries generally, including functionality for reading data from a data source, writing data to a data source, as well as moving data and computation. The query component 220 captures a particular query or representation thereof such as an operator tree. The execution engine component 210 can be custom tailored to the particular query afforded by the query component 220 to optimize performance, for instance. Additionally, the policy component 230 can include one or more policies regarding resources with respect to executing or evaluating the particular query. For instance, the policy component 230 can specify a minimum amount of resources or a preferred amount of resources. The minimum amount of resources can be specified to ensure a level of performance such as streaming without intermediate data materialization. The preferred amount is that desired for a specific level of performance greater than the minimum. The policies can be determined automatically as a function of the particular query and optionally information regarding the data, specified manually with input from a user, or semi-automatically including automatic portions and input from a user.

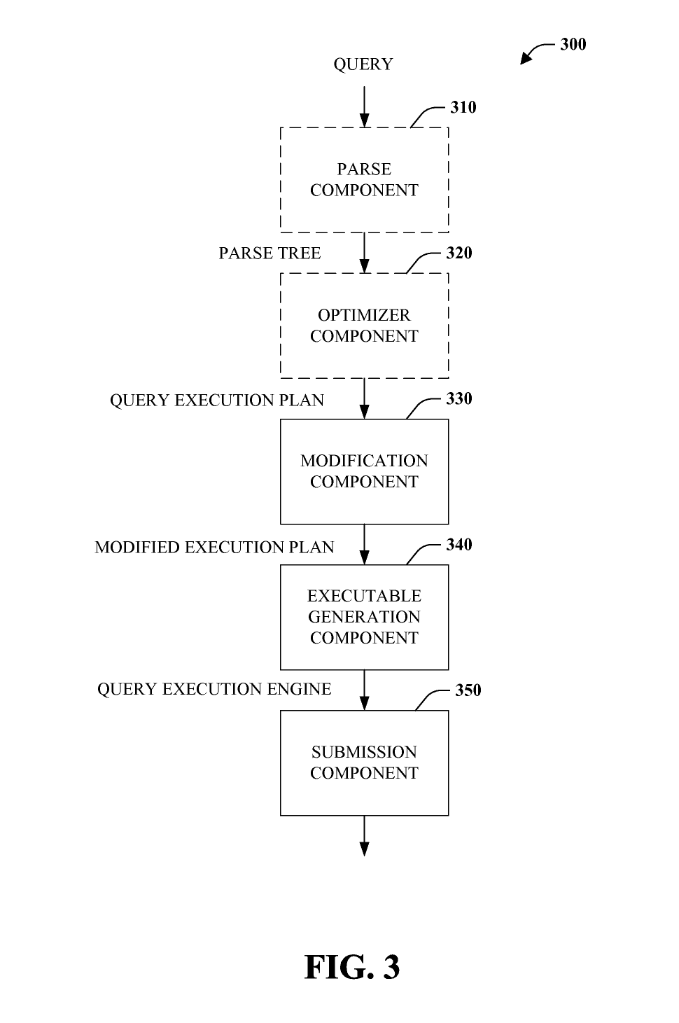

FIG. 3 depicts a system 300 associated with generation of the query execution engine. The system 300 includes parser component 310 that receives a query, such as a relational query specified in SQL (Structured Query Language) from a human user or other entity. The parser component 310 is configured to convert a text string capturing the query into a parse tree based on a grammar of the query language. Subsequently, optimizer component 320 is configured to convert the parse tree into a query execution plan also known as a query plan or execution plan utilizing relational algebra. The execution plan may be represented as an operator tree otherwise known as a query tree. The parse component 310 and the optimizer component 320 can use technology known in the art to perform their respective functions.

Moreover, in accordance with one embodiment, the execution plan can simply be provided or otherwise acquired, as indicated graphically with dashed lines around the parse component 310 and the optimizer component 320. For example, in the context of split query processing, wherein a query is split for processing by different systems and results subsequently combined, the query execution plan can be generated by a parallel data warehouse, or other system, that received a query. The data execution plan can correspond to a portion of the query or the complete submitted query. In the case in which the data execution plan represents an entire query, a relevant portion can be extracted. For example, a portion of the query that is not executed over relational data by the data warehouse can be extracted, or, in other words, a portion directed toward non-relational or unstructured data can be extracted.

Modification component 330 receives the query execution plan from the optimizer component 320 or another entity and generates a modified execution plan. The modified query plan is a version of the query execution plan that accounts for specifics of an underlying data representation and interaction therewith. For example, the modification component 330 can inject shuffle operations that move data between compute nodes. In this manner, data can be transferred without requiring expensive access to a data source such as a physical disk. This enables streaming query processing. The modified execution plan can subsequently be provided or made available to executable generation component 340.

The executable generation component 340 generates a query execution engine that is executable by a system based on the modified execution plan. In other words, a custom query execution engine is generated tailored to a received query or portion thereof. More specifically, an execution engine can be customized for a particular query. Additionally, the query execution engine can include, or be associated with, optional policy information regarding minimum and/or preferred resources.

The submission component 350 is configured to receive or retrieve a query execution engine and submit the query execution engine to a system of execution. For instance, the submission component 350 can submit the query execution engine for execution by or in conjunction with the resource management component 130 of FIG. 1. Subsequently, a result can be returned in response to query execution or evaluation performed by the query execution engine.

What follows is an example of how a query execution engine can be executed by the system 100 of FIG. 1. This is solely exemplary and not meant to limit the scope of invention. Rather, the purpose is to provide additional detail to aid clarity and understanding with respect to one or more aspects of the invention.

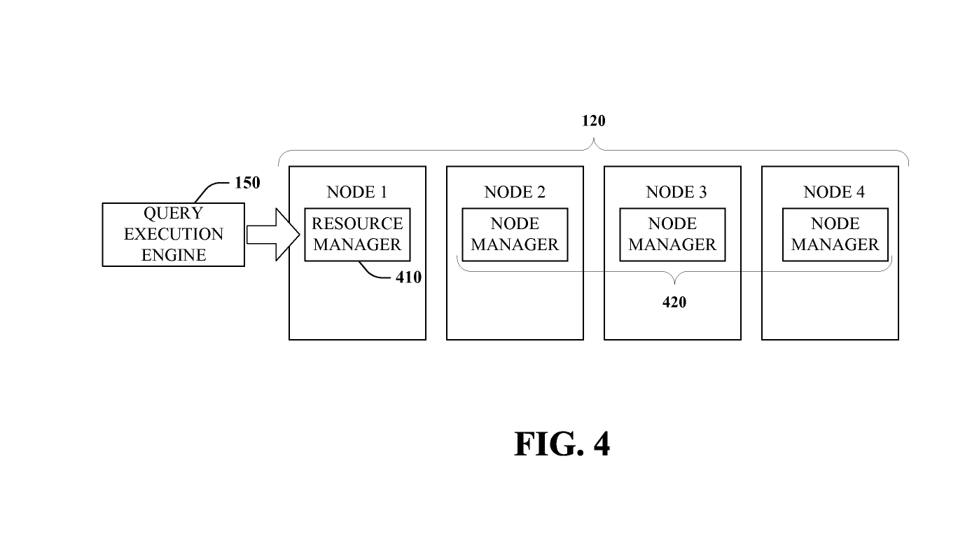

Turning to FIG. 4, four compute nodes 120 are shown. These compute nodes 120 are available to service applications designed for the system 100. Each node has a manager. Node 1, the master node, includes a resource manager and node 2, node, 3, and node 4 include node managers 420. The resource manager 410 is configured to arbitrate resources and thus facilitates management of applications. The node managers 420 are configured as agents for individual nodes, and take instructions from the resource manager 410 and manage resources on individual nodes. The query execution engine 150 customized for a specific query is submitted to the resource manager 410.

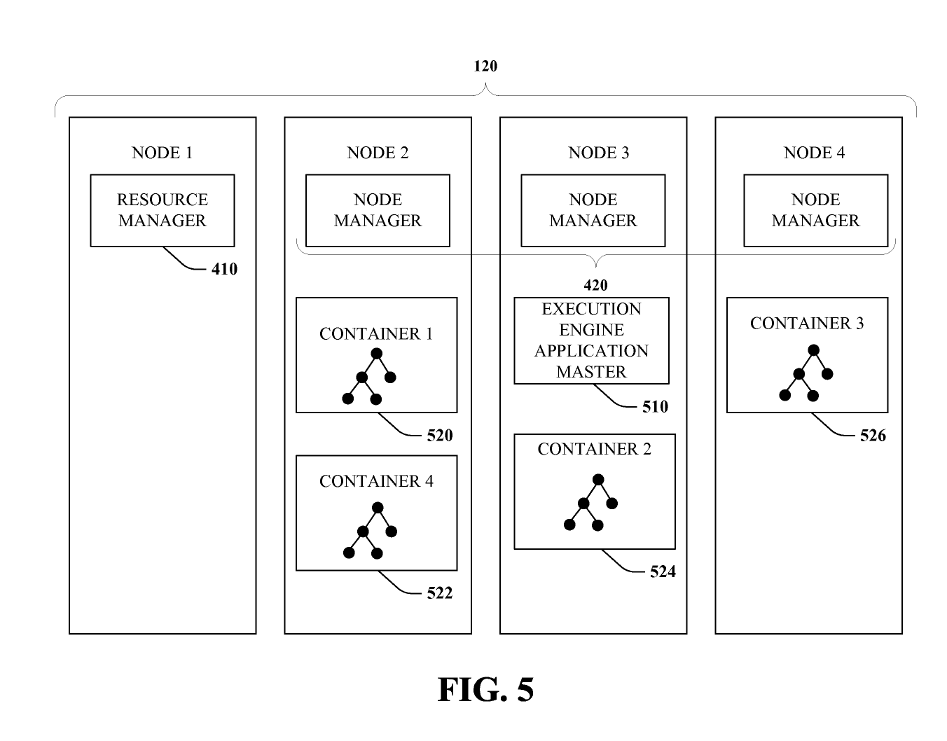

In response to receipt of the query execution engine 150, the resource manager 410, spawns an execution-engine application master process 510 on a node in a cluster, here node 3, as shown in FIG. 5. The functionality of the application master process 510 is defined by the query execution-engine implementation. The application master process 510 requests resource containers from the resource manager 410, to enable query evaluation. The resource containers can define an amount of memory. The application defines the number and size of resource containers. For example, FIG. 5 illustrates a situation where four containers are requested from the resource manager 410 with 1 GB of memory defined per containers. As shown containers are split across compute nodes, however compute nodes can have more the one resource container allocated. In particular, node 2 includes “container 1” 520 and “container 4” 522, node 3 includes “container 2” 524, and node 4 comprises “container 3” 526. After requested containers are allocated, the application master process 510, sends code that defines query execution, for example in terms of a query tree and any parameters of operators to each container so that they can be run. Each query tree can read input data from the storage control component 110, such as the Hadoop file system. Execution of queries in containers is shown here as fully streaming in memory and without intermediate data materializations.

Discussion is now turned toward an exemplary query, execution with a query execution engine as described herein, and execution with MapReduce for comparison. Of course, the query is solely one of many that can be executed. The query and associated discussion is meant to aid clarity and understanding with respect to aspect of the subject invention and not to limit the claims thereto.

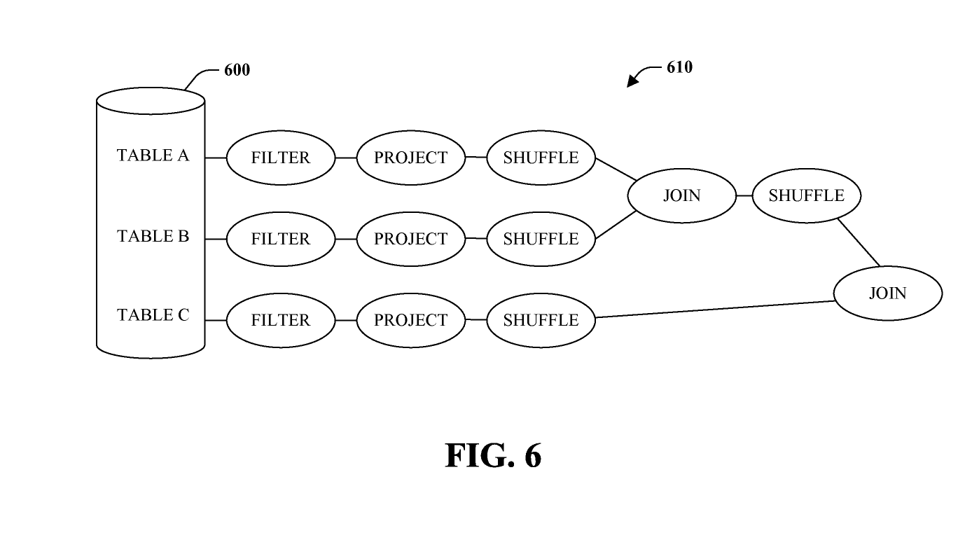

FIG. 6 is a graphical representation of a three-table join query. The cylinder represents durable disk storage 600 of three tables, TABLE A, TABLE B, AND TABLE C. Query operators 610 are specified with respect to the three tables. In particular, for each table filter, project, and shuffle operations are performed. The results associated with TABLE A and TABLE B are then joined and shuffled. These results are then joined with the results associated TABLE C.

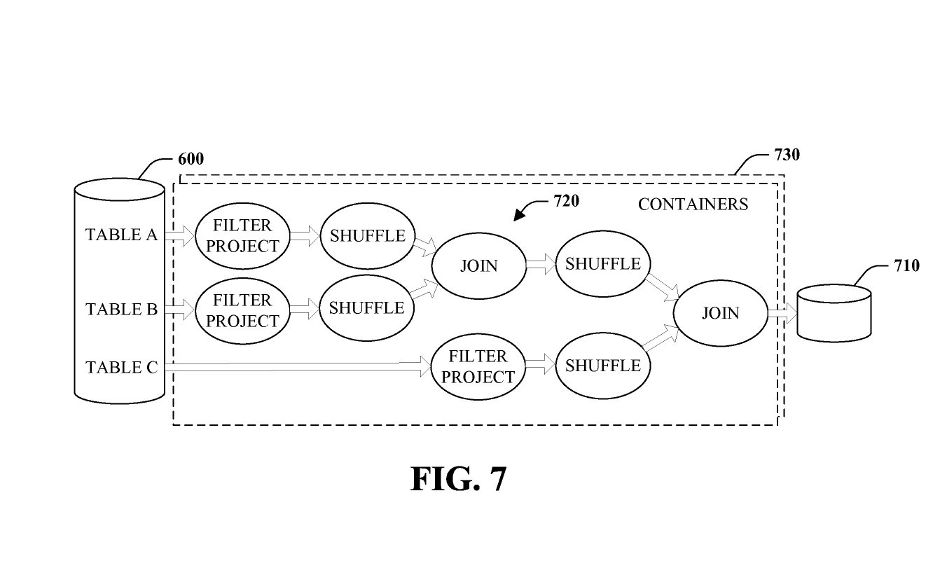

FIG. 7 illustrates how the three-table join query can be implemented in accordance with the query execution engine as described herein. This implementation is fully streaming meaning no intermediate data (non-final result) is written to disk storage, for example. Rather, all operations are implemented in memory. More specifically, data is read from input disk 600 during three phases and written to an output disk 710 once. The three read phases represent the three filter/project operators 720. The one write phase corresponds to when the result of the query is written to the output disk 710. Furthermore, solely two containers 730 are needed to execute the query.

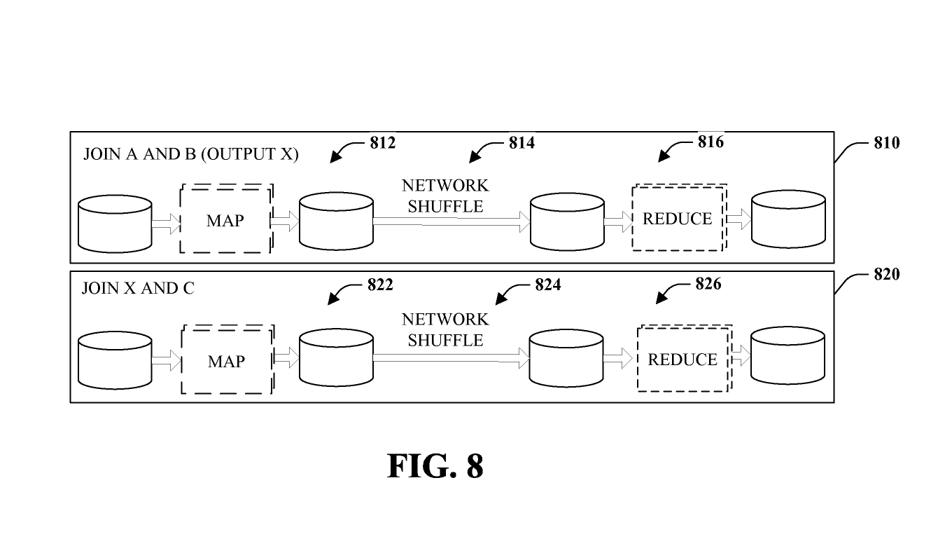

FIG. 8 depicts a MapReduce implementation of the three-table join query process. In a first stage 810, TABLE A is joined with TABLE B with a map operation 812, followed by a network shuffle operation 814, followed by a reduce operation 816, producing OUTPUT X. In a second stage 820, OUTPUT X is joined with TABLE C with a map operation 822, followed by network shuffle, followed by a reduce operation 826. Here, data is read from disk storage during six phases and written back to disk in six phases. The six read phases are illustrated each of the times an arrow is pointing out of a cylinder representing disk storage. Similarly, the six write phases correspond to where an arrow points at a cylinder representing disk storage. Furthermore, eight containers, representing by dashed boxes, need to be acquired at different phases to complete the query processing.

It is easy to see that the query execution-engine implementation performs much better than the MapReduce implementation. More particularly, the query execution-engine implementation reads data from disk storage three times and writes one time, whereas the MapReduce implementation reads from disk storage six times and writes to disk six times. Additionally, the query execution engine implementation utilizes two resource containers versus eight employed by MapReduce. Optimizations may be performed with respect to a MapReduce implementation to improve performance. However, performance will still lag significantly behind the query execution-engine implementation.

In accordance with one implementation, the query execution engine described herein can be a parallel relational query execution engine. In other words, the engine can operate with respect to a relational query specified in SQL, for example, and is configured to execute queries in parallel. For instance, an operator tree representation of query can be simultaneously executed on multiple compute nodes. If implemented in conjunction with a system that employs resource containers, such as Hadoop®, the degree of parallelism can be dictated by the number of containers allocated. Accordingly, policies can specify a degree of parallelism in terms of the number of containers requested.

Note also that the query execution engine can flexible enough to process different data in various ways. For example, a query execution engine can process either row or columnar data. Further, data can be processed in batches on a block-basis (group of tuples) as opposed to on a tuple by tuple basis. Additionally, the batch size need not be static but rather can be dynamically determined, for instance when generating an execution plan.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems above and methods below can include or employ of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example, and not limitation, the optimizer component 320 can employ such mechanisms to produce a query execution plan.

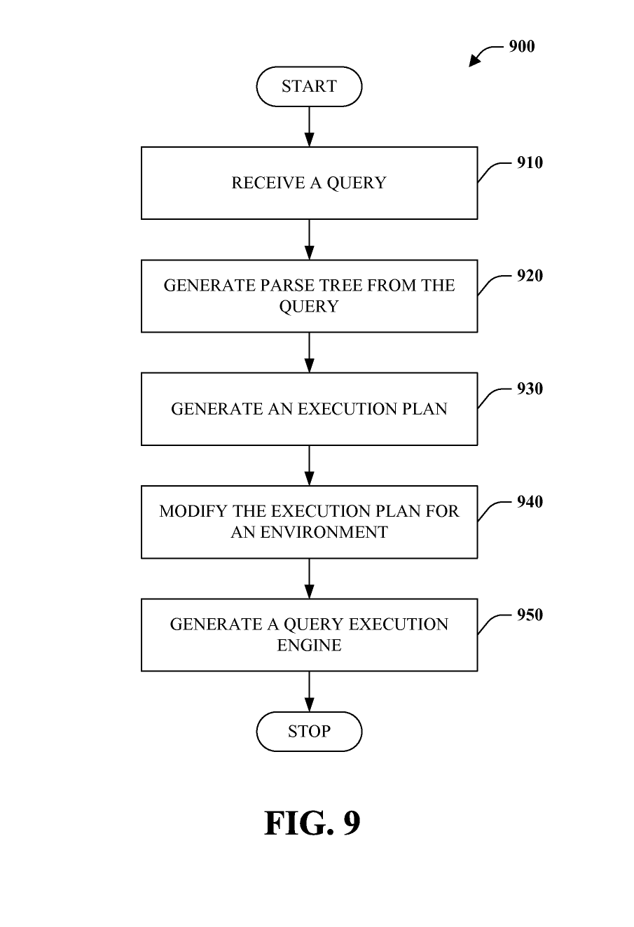

In view of the exemplary systems described above, methodologies that may be implemented in accordance with the disclosed subject matter will be better appreciated with reference to the flow charts of FIGS. 9-12. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 9, illustrates a method of query processing 900. At reference numeral 910, a query is received. For example, the query can be relational query specified in SQL (Structured Query Language) or a portion thereof. At numeral 920, a parse tree is generated from the query based on the grammar of the programming language used to specify the query. The parse tree can capture query operations in an ordered and rooted tree. At reference 930, a query execution plan is generated from the parse tree. The query execution plan defines an efficient strategy for executing the query and may involve employment of optimization techniques. Operators are arranged into a query execution plan in the form of a tree, sometimes called an operator tree or query tree. At reference 940, the execution plan can be modified based on the execution environment. For example, various shuffle operations can be injected into the plan or tree representation, wherein the shuffle operations move data across compute nodes. At reference numeral 950, a query execution engine can be generated from the modified execution plan. In accordance with one implementation, the query execution engine can be an application designed and executed over a resource management component or framework such as but not limited to Hadoop® YARN.

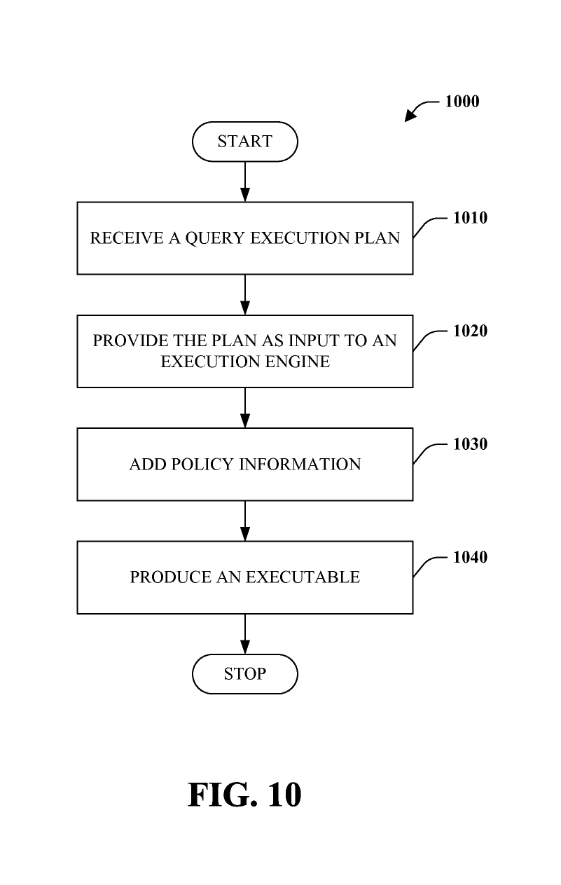

FIG. 10 depicts a method 1000 of query execution-engine generation. At reference 1010, a query execution plan is received, retrieved, or otherwise obtained or acquired. In one instance, the query execution plan can be represented as an operator tree or query tree. At numeral 1020, the execution plan is provided as input to an execution engine. At reference 1030, policy information can be added such as the minimum amount and/or preferred amount of resources for query execution, which can dictate a degree of parallelism. At reference numeral 1040, an executable or application is generated. More specifically, an executable custom query execution engine is generated tailored to the received query.

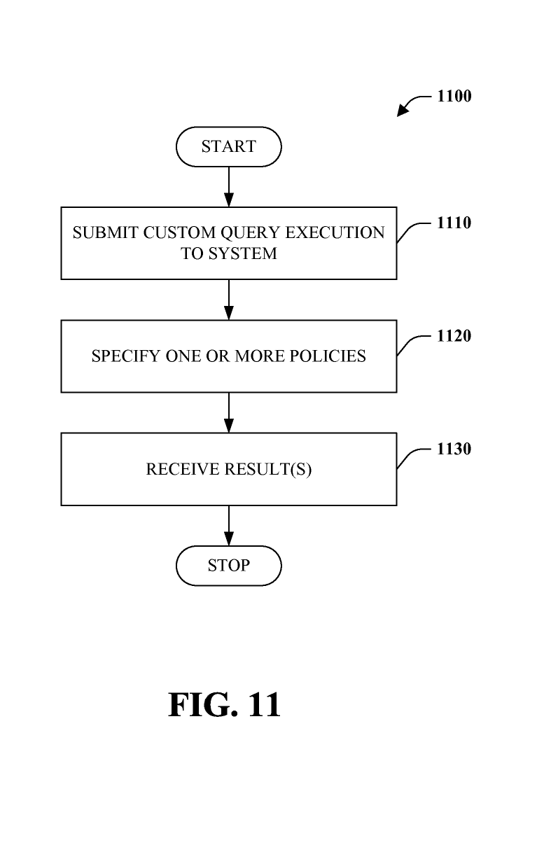

FIG. 11 is a method of query processing 1100. At reference numeral 1110, a custom query execution engine is submitted to a system for execution. By way of example, and not limitation, the custom query execution engine can be submitted for execution over a distributed data source, for example with respect to Hadoop® YARN. At numeral 1120, the one or more policies can be specified regarding the custom query execution engine. For example, a user can specify a minimum and/or preferred mount of resources to support query execution. At numeral 1130, a result is received in response to evaluation of the query by a system.

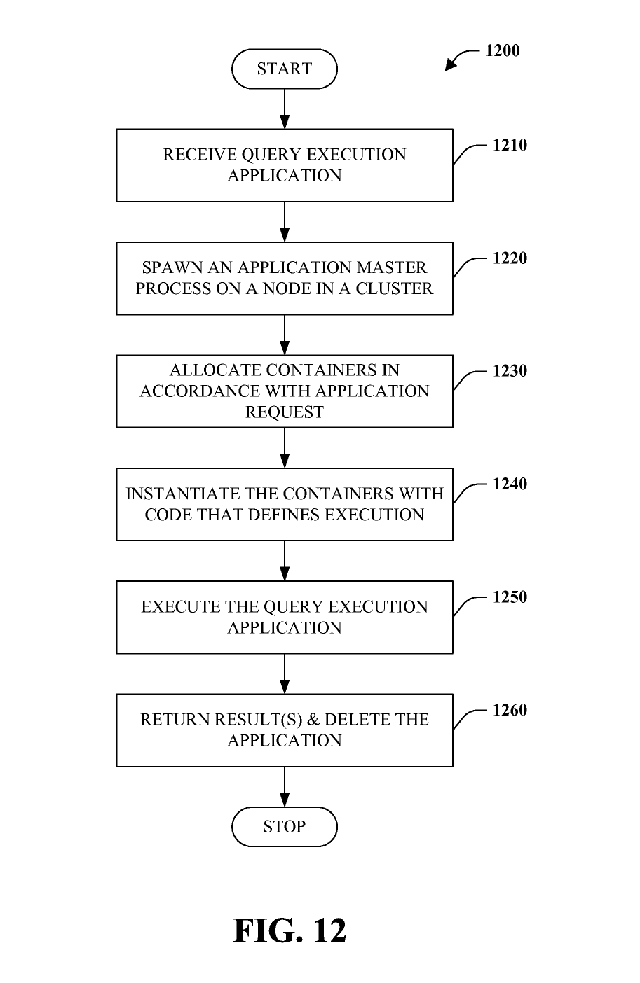

FIG. 12 is a method of query evaluation 1200. At reference numeral 1210, a query execution-engine application is received. An application master is subsequently spawned, at 1220, in a node in a cluster in response to receipt of the query execution-engine application. At reference numeral 1230, resource containers are allocated in accordance with an application request. For example, four resource containers of 1 GB in size can be allocated. At reference 1240, allocated resource containers are instantiated with code that defines query execution. For example, a query tree representation of query execution plan or portion thereof can be instantiated in one or more allocated containers. At numeral 1250, the query execution application is executed. At reference numeral 1260, a result or set of results are returned and the application is deleted.

Various aspects of the subject invention can be optimized in a variety of ways. By way of example, and not limitation, the entire query execution engine may not be submitted every time and subsequently deleted. For instance, functionality standard to for processing many queries can be resident on a processing framework and linked to dynamically as needed. This reduces use of communication bandwidth. As another non-limiting example, an application can reside on the processing framework that caches a submitted query tree and the result. In this case, if the same query is issued, the result can be immediately returned without additional query processing. Similarly, cached results for a portion or a query tree can be returned and a query modified to incorporate those results to reduce processing based on cached results. For instance, if an application or service determines that the top half of query trees looks the same, then the top half of the query tree can be saved along with the results. This could entail employment of machine learning or statistical analysis to make such determinations.

The subject disclosure supports various products and processes that perform, or are configured to perform, various actions regarding a custom query execution engine. What follows are an exemplary method, system, and computer-readable storage medium.

A method comprising employing at least one processor configured to execute computer-executable instructions stored in memory to perform the following acts: generating a custom query execution engine that captures a received query; and submitting the query execution engine to a system configured to execute the query execution engine and evaluate the query. The method further comprises receiving a portion of a query that specifies data on one or more data stores accessible by the system. The method also comprises receiving a query tree that captures the query and modifying the query tree, in one instance to include one or more shuffle operations that move data between compute nodes. The method further comprises generating the custom query execution engine at runtime based on the query and a query independent execution engine. Furthermore, generating the custom query execution engine comprises generating a relational query execution engine configured to operate over non-relational data. Still further the method comprises submitting to the system a minimum number of resource containers for use in executing the query execution engine that ensures streaming execution without intermediate data materialization, and receiving a result of query evaluation from the system.

A system comprises a processor coupled to a memory, the processor configured to execute the following computer-executable component stored in the memory: a first component configured to generate a custom query execution engine from a query execution plan, the custom query execution engine is executable with a resource management framework over a distributed file system. In one instance, the query execution plan is represented as a relational query tree received from a parallel relational database system. Further, the query tree can be a subset of a first query tree produced by the parallel relational database system in response to a query received by the parallel relational database system, and the distributed file system comprises non-relational data. The system further comprises a second component configured to modify the execution plan to include one or more shuffle operations that move data between compute nodes. In one instance, the custom query execution engine is configured to evaluate a query without intermediate data materialization. In another instance, the custom query execution engine is configured to specify at least one of a minimum number of resource containers or a preferred number of resource containers for use in executing the query execution engine.

A computer-readable storage medium having instructions stored thereon that enable at least one processor to perform a method upon execution of the instructions, the method comprises receiving a query, generating a query execution engine customized for the query, and submitting the query execution engine to a system configured to execute the query execution engine and evaluate the query. The method of receiving a query comprises receiving a relational query tree including relational operators. The method further comprises modifying query operator tree to include one or more shuffle operations that move data between compute nodes. Additionally, the method further comprises generating the query execution engine at runtime based on the query and a query independent execution engine.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated a myriad of additional or alternate examples of varying scope could have been presented, but have been omitted for purposes of brevity.

As used herein, the terms “component” and “system,” as well as various forms thereof (e.g., components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The conjunction “or” as used in this description and appended claims is intended to mean an inclusive “or” rather than an exclusive “or,” unless otherwise specified or clear from context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the foregoing instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

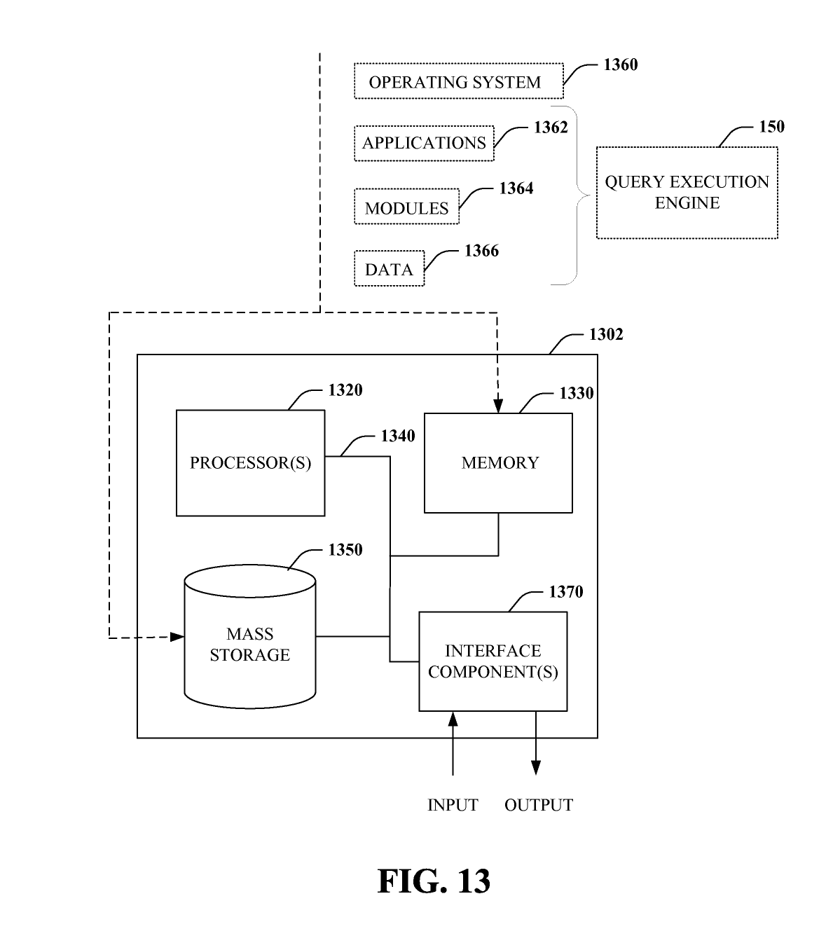

In order to provide a context for the claimed subject matter, FIG. 13 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 13, illustrated is an example general-purpose computer or computing device 1302 (e.g., desktop, laptop, tablet, server, hand-held, programmable consumer or industrial electronics, set-top box, game system, compute node . . . ). The computer 1302 includes one or more processor(s) 1320, memory 1330, system bus 1340, mass storage 1350, and one or more interface components 1370. The system bus 1340 communicatively couples at least the above system components. However, it is to be appreciated that in its simplest form the computer 1302 can include one or more processors 1320 coupled to memory 1330 that execute various computer executable actions, instructions, and or components stored in memory 1330.

The processor(s) 1320 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 1320 may also be implemented as a combination of computing devices, for example a combination of a DSP and a microprocessor, a plurality of microprocessors, multi-core processors, one or more microprocessors in conjunction with a DSP core, or any other such configuration.

The computer 1302 can include or otherwise interact with a variety of computer-readable media to facilitate control of the computer 1302 to implement one or more aspects of the claimed subject matter. The computer-readable media can be any available media that can be accessed by the computer 1302 and includes volatile and nonvolatile media, and removable and non-removable media. Computer-readable media can comprise computer storage media and communication media.

Computer storage media includes volatile and nonvolatile, removable and non-removable media implemented in any method or technology for storage of information such as computer-readable instructions, data structures, program modules, or other data. Computer storage media includes memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other like mediums that can be used to store, as opposed to transmit, the desired information accessible by the computer 1302. Accordingly, computer storage media excludes modulated data signals.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1330 and mass storage 1350 are examples of computer-readable storage media. Depending on the exact configuration and type of computing device, memory 1330 may be volatile (e.g., RAM), non-volatile (e.g., ROM, flash memory . . . ) or some combination of the two. By way of example, the basic input/output system (BIOS), including basic routines to transfer information between elements within the computer 1302, such as during start-up, can be stored in nonvolatile memory, while volatile memory can act as external cache memory to facilitate processing by the processor(s) 1320, among other things.

Mass storage 1350 includes removable/non-removable, volatile/non-volatile computer storage media for storage of large amounts of data relative to the memory 1330. For example, mass storage 1350 includes, but is not limited to, one or more devices such as a magnetic or optical disk drive, floppy disk drive, flash memory, solid-state drive, or memory stick.

Memory 1330 and mass storage 1350 can include, or have stored therein, operating system 1360, one or more applications 1362, one or more program modules 1364, and data 1366. The operating system 1360 acts to control and allocate resources of the computer 1302. Applications 1362 include one or both of system and application software and can exploit management of resources by the operating system 1360 through program modules 1364 and data 1366 stored in memory 1330 and/or mass storage 1350 to perform one or more actions. Accordingly, applications 1362 can turn a general-purpose computer 1302 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, query execution engine 150, can be, or form part, of an application 1362, and include one or more modules 1364 and data 1366 stored in memory and/or mass storage 1350 whose functionality can be realized when executed by one or more processor(s) 1320.

In accordance with one particular embodiment, the processor(s) 1320 can correspond to a system on a chip (SOC) or like architecture including, or in other words integrating, both hardware and software on a single integrated circuit substrate. Here, the processor(s) 1320 can include one or more processors as well as memory at least similar to processor(s) 1320 and memory 1330, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the query execution engine 150 and/or associated functionality can be embedded within hardware in a SOC architecture.

The computer 1302 also includes one or more interface components 1370 that are communicatively coupled to the system bus 1340 and facilitate interaction with the computer 1302. By way of example, the interface component 1370 can be a port (e.g., serial, parallel, PCMCIA, USB, FireWire . . . ) or an interface card (e.g., sound, video . . . ) or the like. In one example implementation, the interface component 1370 can be embodied as a user input/output interface to enable a user to enter commands and information into the computer 1302, for instance by way of one or more gestures or voice input, through one or more input devices (e.g., pointing device such as a mouse, trackball, stylus, touch pad, keyboard, microphone, joystick, game pad, satellite dish, scanner, camera, other computer . . . ). In another example implementation, the interface component 1370 can be embodied as an output peripheral interface to supply output to displays (e.g., LCD, LED, plasma . . . ), speakers, printers, and/or other computers, among other things. Still further yet, the interface component 1370 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method, comprising:
employing at least one processor configured to execute computer-executable instructions stored in memory to perform the following acts:
generating a custom query execution engine that captures a received query; and
submitting the query execution engine to a system configured to execute the query execution engine and evaluate the query.

2. The method of claim 1 further comprises receiving a portion of a query that specifies data on one or more data stores accessible by the system.

3. The method of claim 1 further comprises receiving a query tree that captures the query.

4. The method of claim 3 further comprises modifying the query tree to include one or more shuffle operations that move data between compute nodes.

5. The method of claim 1 further comprises generating the custom query execution engine at runtime based on the query and a query independent execution engine.

6. The method of claim 1, generating the custom query execution engine comprises generating a relational query execution engine configured to operate over non-relational data.

7. The method of claim 1 further comprises submitting to the system a minimum number of resource containers for use in executing the query execution engine that ensures streaming execution without intermediate data materialization.

8. The method of claim 1 further comprises receiving a result of query evaluation from the system.

9. A system, comprising:
a processor coupled to a memory, the processor configured to execute the following computer-executable component stored in the memory:
a first component configured to generate a custom query execution engine from a query execution plan, the custom query execution engine is executable with a resource management framework over a distributed file system.

10. The system of claim 9, the query execution plan is represented as a relational query tree.

11. The system of claim 10, the query tree is received from a parallel relational database system.

12. The system of claim 11, the query tree is a subset of a first query tree produced by the parallel relational database system in response to a query received by the parallel relational database system.

13. The system of claim 10, the distributed file system comprises non-relational data.

14. The system of claim 9, further comprising a second component configured to modify the execution plan to include one or more shuffle operations that move data between compute nodes.

15. The system of claim 9, the custom query execution engine is configured to evaluate a query without intermediate data materialization.

16. The system of claim 9, the custom query execution engine is configured to specify at least one of a minimum number of resource containers or a preferred number of resource containers for use in executing the query execution engine.

17. A computer-readable storage medium having instructions stored thereon that enable at least one processor to perform a method upon execution of the instructions, the method comprising:
receiving a query;
generating a query execution engine customized for the query; and
submitting the query execution engine to a system configured to execute the query execution engine and evaluate the query.

18. The computer-readable storage medium of claim 17, the method of receiving a query comprises receiving a relational query tree including relational operators.

19. The computer-readable storage medium of claim 18, the method further comprises modifying query operator tree to include one or more shuffle operations that move data between compute nodes.

20. The computer-readable storage medium of claim 17, the method further comprises generating the query execution engine at runtime based on the query and a query independent execution engine.
